(19) United States
(12) Patent Application Publication
(10) Pub. No.: US 2002/0012802 A1
(43) Pub. Date: Jan. 31, 2002

(54) Automobile part

(76) Inventor: Seiko Motegi, Tokyo (JP)

Correspondence Address: NATH & ASSOCIATES, PLLC, Sixth Floor, 1030 15th Street, N.W., Washington, DC, 20005, US

(21) Appl. No.: 09/873,350

(22) Filed: Jun. 5, 2001

(30) Foreign Application Priority Data
Jun. 19, 2000 (JP) 2000-183298

(51) Int. Cl. B32B 27/00; B32B 27/40

(52) U.S. Cl. 428/423.1; 428/423.7

(57) ABSTRACT

An automobile key has a key grip and a urethane coating applied to at least a portion of the key grip. The key grip includes thermoplastic elastomer. The key grip may be a single molded body of thermoplastic elastomer or a dual molded body of a thermoplastic elastomer outer portion and a thermoplastic resin inner portion. The hardness of the thermoplastic elastomer is preferably 50-95 according to JIS K 6253 TYPE A. The hardness of the urethane coating is preferably 50-95 according to JIS K 6253 TYPE A.

### BACKGROUND OF THE INVENTION

The present invention relates to an automobile part that has a molded body and a polymer coating on the molded body. More particularly, the invention relates to an automobile part that has a molded body including thermoplastic elastomer and a urethane coating on the molded body.

Generally, in view of environmental problems, thermoplastic resins that are easily recyclable and reusable are widely used as materials for molded bodies of automobile parts. For example, for automobile parts such as instrument panels, levers, knobs, and keys, hard thermoplastic resins such as polycarbonate and acrylic resin and soft thermoplastic resins such as polypropylene are used. To protect the molded bodies and improve the appearance of the molded bodies, secondary process such as printing or coating is applied to the molded bodies.

The use of impact-absorbing materials for automobile interior parts has recently been proposed. Specifically, replacement of hard thermoplastic resins such as polycarbonate and acrylic resin with soft thermoplastic resins such as polypropylene or thermoplastic elastomers is proposed.

Elasticity is desired for the above impact-absorbing materials. However, polypropylene soft thermoplastic resins are not elastic. Also, there is room for improvement for polypropylene soft thermoplastic resins to be used for absorbing impacts. Further, due to lack of polar groups in the polypropylene soft thermoplastic resins, paint adheres poorly to them and resistance to secondary treatment such as printing and coating is relatively high. Therefore, addition of an agent which provides improved adhesion of paint, roughing of the molded body, or physical or chemical processes such as applying a primer has been required. This increased the number of manufacturing steps and increased costs.

On the other hand, thermoplastic elastomers are elastic and reusable. Moreover, the productivity of thermoplastic elastomers in the manufacturing process is high. However, thermoplastic elastomers are generally inferior to hard thermoplastic resins and soft thermoplastic resins in terms of abrasion resistance and scratch resistance. Further, flow marks appear in the molded body formed of thermoplastic elastomer. Therefore, the surface condition of such a molded body is poor and resistance to secondary treatment is relatively high.

### BRIEF SUMMARY OF THE INVENTION

An object of the present invention is to provide an automobile part that is easily recyclable and reusable, elastic, and easily handled, and that has good abrasion resistance and scratch resistance as well as low resistance to secondary treatments.

An automobile part of the invention has a molded body including thermoplastic elastomer having surface and a urethane coating applied to at least a portion of the surface.

Other aspects and advantages of the invention will become apparent from the following description, taken in conjunction with the accompanying drawings, illustrating by way of example the principles of the invention.

### BRIEF DESCRIPTION OF THE SEVERAL VIEWS OF THE DRAWING

FIG. 1A is a partially broken sectional view of an automobile key of Examples 1 and 2.

FIG. 1B is a side sectional view of an automobile key of Examples 1 and 2.

FIG. 2 is a side sectional view of an automobile key of Comparisons 1 and 2.

FIG. 3A is a partially broken sectional view of an automobile key of Examples 3 and 4.

FIG. 3B is a side sectional view of an automobile key of Examples 3 and 4.

FIG. 4 is a side sectional view of an automobile key of Comparisons 3 and 4.

The invention, together with objects and advantages thereof, may best be understood by reference to the following description of the presently preferred embodiments together with the accompanying drawings in which:

### DETAILED DESCRIPTION OF THE PREFERRED EMBODIMENTS

A first embodiment of the present invention is described in detail below.

A first embodiment of an automobile part includes a molded body formed of thermoplastic elastomer and a urethane coating formed on at least a portion of the surface of the molded body.

The thermoplastic elastomer is a polymer compound that becomes soft when heated and has rubber elasticity at room temperature. The thermoplastic elastomer is flexible and deformed elastically by external force. The thermoplastic elastomer is a multi-phase polymer compound that includes hard segments and soft segments. Hard segments correspond to cross-linked points of three-dimensional mesh of vulcanized rubber and restrict the plastic deformation of polymer that forms the thermoplastic elastomer. Soft segments are chains of the mesh that exhibit entropy elasticity and deform plastically.

The thermoplastic elastomer includes a polystyrene thermoplastic elastomer, a polyolefin thermoplastic elastomer, a polybutadiene thermoplastic elastomer, and a polyester thermoplastic elastomer.

In the polystyrene thermoplastic elastomer, for example, hard segments are polystyrene and soft segments are polybutadiene or polyisoprene.

In the polyolefin thermoplastic elastomer, for example, hard segments are polyethylene or polypropylene and soft segments are styrene-butadiene rubber or ethylene-propylene rubber.

In the polybutadiene thermoplastic elastomer, for example, hard segments are syndiotactic-1, 2-polybutadiene and soft segments are polybutadiene.

In the polyester thermoplastic elastomer, for example, hard segments are polyester or aromatic polyester and soft segments are aliphatic polyether or aliphatic polyester.

The methods for molding the molded body include, but are not limited to, injection molding, extrusion molding, compression molding, and blow molding.

The hardness of the molded body can be any magnitude as long as the molded body is an elastic body at room temperature. Specifically, the molded body has a hardness of 95 or less (Hardness Testing Methods for Rubber, Vulcanized or Thermoplastic, JIS K 6253 type A is a Japanese Industrial Standard specifying the hardness test). In that range of hardness, the molded body is expected to serve as an elastic body. The molded body does not serve as an elastic body when the hardness is over 95.

In the hardness test, a needle that has a predetermined shape is pressed against a surface of a specimen with a bias force of a spring. The specimen has a thickness 6 mm or more. The hardness of the specimen is measured based on the depth to which the needle advances in the specimen. A testing machine having such a needle is called a durometer.

The hardness of the molded body formed of polystyrene thermoplastic elastomer is preferably 15-95 according to JIS K 6253 TYPE A. The molded body exhibits rubber elasticity at that range. When the hardness is below 15, the molding capability deteriorates and adhesion of the urethane coating to the molded body is reduced.

The hardness of the molded body formed of polyolefin thermoplastic elastomer is preferably 40-95 (JIS K 6253 TYPE A). The molded body exhibits rubber elasticity at that range. When the hardness is below 40, the molding capability deteriorates and adhesion of the urethane coating to the molded body is reduced.

The hardness of the molded body formed of polybutadiene thermoplastic elastomer is preferably 40-95 (JIS K 6253 TYPE A). The molded body exhibits rubber elasticity at that range. When the hardness is below 40, the capability deteriorates and adhesion of the urethane coating to the molded body is reduced.

The hardness of the molded body formed of polyester thermoplastic elastomer is preferably 50-95 (JIS K 6253 TYPE A). The molded body exhibits rubber elasticity at that range. When the hardness is below 50, the molding capability deteriorates and adhesion of the urethane coating to the molded body is reduced.

A urethane coating is a film layer of a synthetic polymer compound which has a urethane. For example, the urethane coating is formed of a reaction compound of a polyol compound and an isocyanate compound.

The polyol compound is at least one compound selected from the group consisting of polyether polyols, polyester polyols, urethane modified polyols, acrylic polyols, polybutadiene polyols, polyisoprene polyols, polyolefin polyols, saponified ethylene-vinyl acetate copolymers, phosphorus-containing polyols, silicon-containing polyols, halogen-containing polyols, and incombustible polyols.

The isocyanate compound is at least one compound selected from the group consisting of xylylene diisocyanate, tolylene diisocyanate, bitolylene diisocyanate, diphenylmethane diisocyanate, dimethyldiphenylmethane diisocyanate, phenylene diisocyanate, triphenylmethane triisocyanate, hexamethylene diisocyanate, cycrohexyl diisocyanate, dicyclohexylmethane diisocyanate, isophorone diisocyanate, methylcycrohexylene diisocyanate, hexamethylene diisocyanate, lysine diisocyanate, naphthalene diisocyanate, urethane modified diisocyanate, urea modified polyisocyanate, masked block isocyanate, and a isocyanate polymer, a modified coumpound thereof, a derivative thereof or a prepolymer thereof.

A urethane coating may further include various compounding ingredients such as a plasticizer, a reaction catalyst, a coupling agent, a colorant, an inorganic filler, a delustering agent, a suspending agent, a thixotropic agent, an antioxidant, a UV-ray absorbent agent, a light stabilizer, an antistatic agent, anti-hydrolysis agent, a dye or pigment, and a flame retarder.

A urethane coating is formed by applying urethane paint that includes the polyol compound, the isocyanate compound, and optionally the compounding ingredient to the surface of the molded body. The urethane paint may be applied to the entire or a part of the molded body. The urethane paint may optionally include various solvents such as aromatic hydrocarbon organic solvent, aliphatic hydrocarbon organic solvent, ketone organic solvent, and ester organic solvent.

The methods for applying urethane paint are not limited and known applying methods such as brushing, spraying, roll coating, electrostatic coating may be used. The methods for hardening urethane paint are not limited and known hardening methods such as thermal hardening, photo-curing, and moisture hardening may be used.

The thickness of the urethane coating is preferably 5-100 μm. When the thickness is less than 5 μm, abrasion resistance of the coating is insufficient. When the thickness is more than 100 μm, defects such as scratches tend to appear on the coating. More preferred thickness is 10-60 μm.

The hardness of the urethane coating can be any magnitude so long as the urethane coating serves as an elastic body at room temperature. Specifically, the urethane coating has hardness of 95 or (JIS K 6253 TYPE A). In that range of hardness, the urethane coating has rubber elasticity and is expected to serve as an elastic body. The urethane coating does not serve as an elastic body when the hardness is over 95. In the light of abrasion resistance of the coating and a adhesion of the coating to the molded body, The hardness of the coating is preferably 50-95. When the hardness is less than 50, coefficient of friction of the urethane coating increases. Therefore, the urethane coating is subjected to friction.

The first embodiment has following advantages.

The urethane coating is formed on at least a portion of the surface of the molded body. The use of the urethane coating improves abrasion resistance and scratch resistance as well as the surface condition of the molded body. Thus, resistance to secondary treatment of the molded body is reduced. Oil resistance and weather resistance are also improved. When the hardness of the urethane coating is 50-95 (JIS K 6253 TYPE A), it can serve as an elastic body.

The molded body is an elastic material which is formed of the thermoplastic elastomer. An automobile part made of such a molded body is easily recyclable, reusable, and more elastic. The thermoplastic elastomer melts at high temperature and are easily processed. The thermoplastic elastomer may be produced with high productivity and low costs.

In particular, when the thermoplastic elastomer is a polyester thermoplastic elastomer, the automobile part is is easily recyclable and reusable, more elastic, and can be produced at low costs. Also, oil resistance and heat resistance of the part are relatively high.

A second embodiment of the present invention will now be described, focusing on points that differ from the first embodiment.

In the second embodiment, an automobile part includes a multiple molded body that includes a thermoplastic elastomer and a synthetic resin inside the thermoplastic elastomer and a urethane coating on at least a portion of the surface of the multiple molded body.

For the synthetic resin inside the thermoplastic elastomer of the multiple molded body, synthetic resins that have greater rigidity than the thermoplastic elastomer are applicable. The synthetic resin serves as a core. The use of the synthetic resin that has greater rigidity than the thermoplastic elastomer easily provides a rigid molded body.

The synthetic resins serving as a core include, but are not limited to, thermoplastic resins such as polycarbonate, acrylic resin, polypropylene, polyethylene, acrylonitrile-butadiene-styrene (ABS) resin, acrylonitrile-styrene resin, polystyrene and thermosetting resins such as epoxy resin and phenol resin. The synthetic resin is selected depending on the rigidity of the automobile part. In the light of manufacturing ease, the synthetic resin is preferably a thermoplastic resin. Thermoplastic resins become soft by heating, plastically deform by external force, and restore their shape after the eliminating heat or external force. Therefore, the use of the thermoplastic resin not only provides rigidity but also makes it easier to produce the multiple molded body by a method such as heat fusion.

The multiple molded bodies include, but are not limited to, a dual molded body formed of polyester thermoplastic elastomer and acrylonitrile-butadiene-styrene (ABS) thermoplastic resin, a dual molded body formed of polystyrene thermoplastic elastomer and polypropylene thermoplastic resin, a dual molded body formed of polyurethane thermoplastic elastomer and epoxy thermosetting resin, and a dual molded body formed of polybutadiene thermoplastic elastomer and phenol thermosetting resin.

The previously mentioned methods for molding the first embodiment are also applicable to the second embodiment. The multiple molded bodies may be integrated with an adhesive or may be integrated mechanically although the integration forms are not so limited. In the case of the multiple molded body formed of thermoplastic elastomer and thermosetting resin, the two components may be integrated by heat fusion during injection molding.

The thickness of the thermoplastic elastomer in the multiple molded body is not limited as long as the multiple molded body is elastic at room temperature. The thickness varies depending on the hardness of the thermoplastic elastomer. When the hardness of the thermoplastic elastomer is low, the thickness is 0.3 mm or more, more preferably, 0.5 mm or more. When the hardness of the thermoplastic elastomer is high, the thickness is 1.0 mm or more.

The urethane coating is formed by applying the above-described urethane paint on the surface of the dual molded body. The urethane paint may be applied to the entire or a part of the surface of the dual molded body.

In addition to the advantages of the first embodiment, the second embodiment has the following advantages.

The multiple molded body has the thermoplastic resin inside the thermoplastic elastomer. The use of the multiple molded body provides an automobile part with both elasticity and rigidity. For example, when an article such as a circuit, which is vulnerable to external force, is placed in the molded body, the article may be placed inside the thermoplastic resin with appropriate rigidity to protect the article from the external forces.

When the multiple molded body is formed of thermoplastic elastomer and thermoplastic resin, the molded body of such combination may be produced easily by heat fusion. Thus, manufacturing ease is improved.

### EXAMPLES

The two embodiment described above will be described in detail in Examples. The invention is not limited in any way by the Examples.

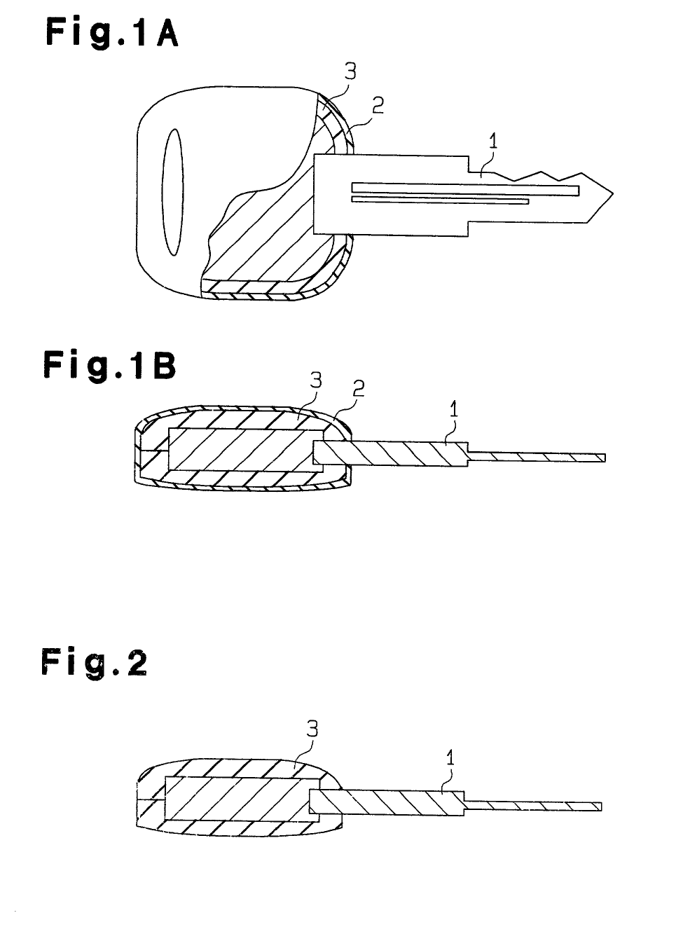

As shown in FIGS. 1A and 1B, an automobile key of Examples 1 and 2 includes a key body 1, which is formed by a metal plate, a key grip 3, which is a molded body and which is formed of polyester thermoplastic elastomer, and a urethane coating 2, which is applied to the surface of the key grip 3.

As shown in FIG. 2, an automobile key of Comparisons 1 and 2 includes a key body 1, which is formed by a metal plate, and a key grip 3, which is as a molded body and which is formed polyester thermoplastic elastomer only.

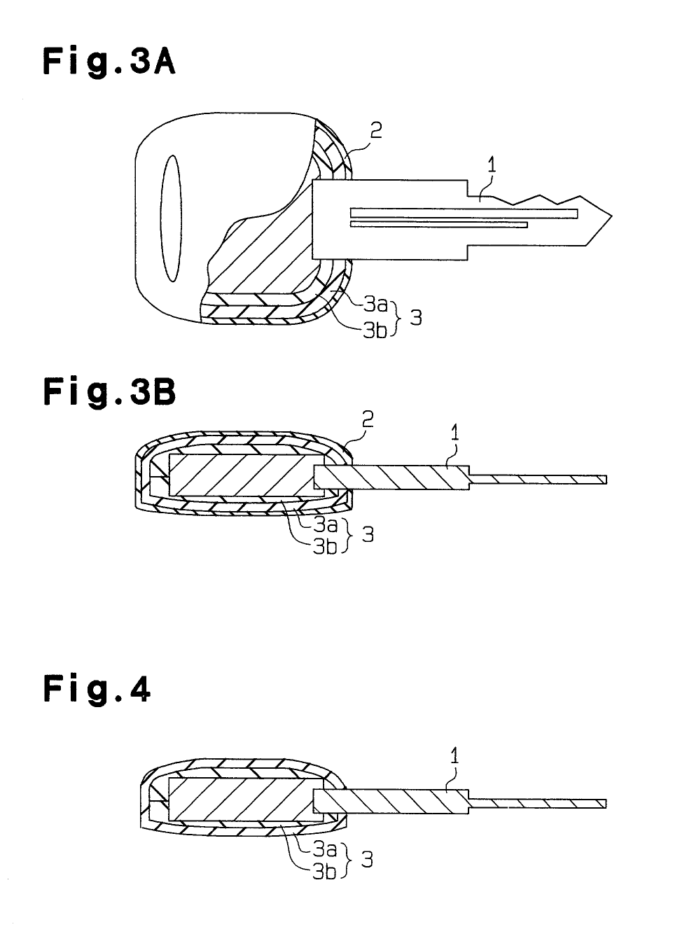

As shown in FIGS. 3A and 3B, an automobile key of Examples 3 and 4 comprises a key body 1, which is formed by a metal plate, a key grip 3, which is a dual molded body, and a urethane coating 2, which is applied to the surface of the key grip 3. The key grip 3 includes an outer portion 3a formed of polyester thermoplastic elastomer and an inner portion 3b formed of thermoplastic resin. The inner portion 3b serves as a core. The urethane coating 2 is formed on the surface of the outer portion 3a.

As shown in FIG. 4, an automobile key of Comparisons 3 and 4 comprises a key body 1, which is formed by a metal plate, and a key grip 3, which is a dual molded body only. The key grip 3 includes an outer portion 3a formed of polyester thermoplastic elastomer and an inner portion 3b formed of thermoplastic resin.

### Example 1

To 90% by weight of a solid paint material composed of polyester polyol (hydroxyl group value (OH):174) and xylylene diisocyanate (isocyanate content (NCO):11.5%) was added 10% by weight of a reactive polyester plasticizer (W-860, DAINIPPON INK AND CHEMICALS, INCORPORATED) to prepare a urethane paint for a coating. Separately, the key grip 3 shown in FIGS. 1A and 1B was injection-molded from polyester thermoplastic elastomer (PRIMALLOY™, MITSUBISHI CHEMICAL CORPORATION), which is a polymer alloy in which rubber components are dispersed in a polymer matrix. The prepared urethane paint was sprayed uniformly on the surface of the key grip 3 and hardened by heating at 80° C. for 15-30 minutes to form the urethane coating 2. The thickness of the urethane coating 2 after heating was 60 μm.

### Example 2

To 95% by weight of a solid paint material composed of polyether polyol (OH:56) and methylcycrohexylene diisocyanate (NCO:11.0%) was added 5% by weight of dibutylphthalate as a plasticizer to prepare a urethane paint for a coating. Separately, the key grip 3 shown in FIGS. 1A and 1B was injection-molded from polyester thermoplastic elastomer (GRILUX™, DAINIPPON INK AND CHEMICALS, INC.), which is a block copolymer of aromatic polyester and aliphatic polyether or aliphatic polyester. The prepared urethane paint was sprayed uniformly on the surface of the key grip 3 and hardened by heating at 80° C. for 15-30 minutes to form the urethane coating 2. The thickness of the urethane coating 2 after heating was 10 μm.

### Example 3

To 90% by weight of a solid paint material composed of polyester polyol (OH:174) and xylylene diisocyanate (NCO:11.5%) was added 10% by weight of a reactive polyester plasticizer (W-860, DAINIPPON INK AND CHEMICALS, INCORPORATED) to prepare a urethane paint for a coating. Separately, the key grip 3 shown in FIGS. 3A and 3B was injection-molded from polyester thermoplastic elastomer (PRIMALLOY™, MITSUBISHI CHEMICAL CORPORATION) and ABS thermoplastic resin to be a dual molded body. The prepared urethane paint was sprayed uniformly on the surface of the key grip 3 and hardened by heating at 80° C. for 15-30 minutes to form the urethane coating 2. The thickness of the urethane coating 2 after heating was 60 μm.

### Example 4

To 95% by weight of a solid paint material composed of polyether polyol (OH:56) and methylcycrohexylene diisocyanate (NCO:11.0%) was added 5% by weight of dibutylphthalate as a plasticizer to prepare a urethane paint for a coating. Separately, the key grip 3 shown in FIGS. 3A and 3B was injection-molded from polyester thermoplastic elastomer (GRILUX™, DAINIPPON INK AND CHEMICALS, INC.) and ABS thermoplastic resin to be a dual molded body. The prepared urethane paint was sprayed uniformly on the surface of the key grip 3 and hardened by heating at 80° C. for 15-30 minutes to form the urethane coating 2. The thickness of the urethane coating 2 after heating was 10 μm.

### Comparison 1

The key grip 3 shown in FIG. 2 was injection-molded from polyester thermoplastic elastomer (PRIMALLOY™, MITSUBISHI CHEMICAL CORPORATION), which is a polymer alloy in which styrene is dispersed in a polyester polymer matrix.

### Comparison 2

The key grip 3 shown in FIG. 2 was injection-molded from polyester thermoplastic elastomer (GRILUX™, DAINIPPON INK AND CHEMICALS, INC.), which is a block copolymer of aromatic polyester and aliphatic polyether or aliphatic polyester.

### Comparison 3

The key grip 3 shown in FIG. 4 was injection-molded from polyester thermoplastic elastomer (PRIMALLOY™, MITSUBISHI CHEMICAL CORPORATION) and ABS thermoplastic resin to be a dual molded body.

### Comparison 4

The key grip 3 shown in FIG. 4 was injection-molded from polyester thermoplastic elastomer (GRILUX™, DAINIPPON INK AND CHEMICALS, INC.) and ABS thermoplastic resin to be a dual molded body.

Table 1 shows abrasion resistance and surface condition of the molded body in Examples of the present invention and Comparisons. The abrasion resistance was evaluated in an abrasion resistance test. In this test, canvas (a cotton cloth pursuant to JIS L3102 and JIS L1206) was reciprocated ten thousand times with a load 0.98 N per square centimeter against the molded body. After the friction, the appearance of the canvas was observed. The surface condition of the molded body was evaluated by observing appearance defects such as flow marks.

TABLE 1

| | | | Comparison 1, | Comparison 2, |
|---|---|---|---|---|
| | Example 1, 3 | Example 2, 4 | 3 | 4 |
| polyester TPE* | PRIMALLOY ™ | GRILUX ™ | PRIMALLOY ™ | GRILUX ™ |
| JIS K 6253 A | 60 | 90 | 60 | 90 |
| hardness | | | | |
| urethane coating | 60 μm | 10 μm | none | none |
| JIS K 6253 A | 65 | 95 | — | — |
| hardness | | | | |
| abrasion resistance | good | good | bad | bad |
| surface condition | good | good | good | bad |

*TPE = thermoplastic elastomer

As shown in Table 1, both abrasion resistance and surface condition of the molded body are good in Examples 1-4. However, abrasion resistance was bad in Comparisons 1 and 3. Abrasion resistance and surface condition of the molded body were bad in Comparisons 2 and 4.

Taken together, it was confirmed that at least one of abrasion resistance and surface condition was improved and thus the resistance to secondary treatment of the molded body was lowered in Examples 1-4 relative to Comparisons 1-4.

The present examples and embodiments are to be considered as illustrative and not restrictive and the invention is not to be limited to the details given herein, but may be modified within the scope and equivalence of the appended claims.

1. An automobile part comprising:
a molded body including thermoplastic elastomer, wherein the molded body has a surface; and
a urethane coating applied to at least a portion of the surface.

2. The automobile part according to claim 1, wherein the thermoplastic elastomer is at least one selected from the group consisting of a polystyrene thermoplastic elastomer, a polyolefin thermoplastic elastomer, a polybutadiene thermoplastic elastomer, and a polyester thermoplastic elastomer.

3. The automobile part according to claim 1, wherein the thermoplastic elastomer is a polyester thermoplastic elastomer.

4. The automobile part according to claim 3, wherein the polyester thermoplastic elastomer has a hardness of 50-95 according to JIS K 6253 TYPE A.

5. The automobile part according to claim 1, wherein the urethane coating has a hardness of 50-95 according to JIS K 6253 TYPE A.

6. The automobile part according to claim 2, wherein the urethane coating has a hardness of 50-95 according to JIS K 6253 TYPE A.

7. The automobile part according to claim 4, wherein the urethane coating has a hardness of 50-95 according to JIS K 6253 TYPE A.

8. The automobile part according to claim 1, wherein the molded body is a multiple molded body including:
a thermoplastic elastomer; and
a core placed inside the thermoplastic elastomer, wherein the core has a greater rigidity than the thermoplastic elastomer.

9. The automobile part according to claim 8, wherein the molded body is a dual molded body.

10. The automobile part according to claim 8, wherein the core is a synthetic resin.

11. The automobile part according to claim 10, wherein the synthetic resin is a thermoplastic resin.

12. The automobile part according to claim 8, wherein the thermoplastic elastomer is at least one selected from the group consisting of a polystyrene thermoplastic elastomer, a polyolefin thermoplastic elastomer, a polybutadiene thermoplastic elastomer, and a polyester thermoplastic elastomer.

13. The automobile part according to claim 12, wherein the thermoplastic elastomer is a polyester thermoplastic elastomer.

14. The automobile part according to claim 13, wherein the polyester thermoplastic elastomer has a hardness of 50-95 according to JIS K 6253 TYPE A.

15. The automobile part according to claim 8, wherein the urethane coating has a hardness of 50-95 according to JIS K 6253 TYPE A.

16. The automobile part according to claim 12, wherein the urethane coating has a hardness of 50-95 according to JIS K 6253 TYPE A.

17. The automobile part according to claim 14, wherein the urethane coating has a hardness of 50-95 according to JIS K 6253 TYPE A.
